(19) United States
(12) Patent Application Publication
(10) Pub. No.: US 2026/0366682 A1
(43) Pub. Date: Nov. 19, 2026

(54) SOLAR-POWERED ILLUMINATED ART ORB

(71) Applicant: Arthur Chao-Chung WU, Las Vegas, NV (US)

(72) Inventor: Arthur Chao-Chung WU, Las Vegas, NV (US)

(21) Appl. No.: 19/680,966

(22) Filed: May 18, 2026

Related U.S. Application Data
(60) Provisional application No. 63/808,483, filed on May 19, 2025.

(51) Int. Cl. F21L 4/08; F21V 3/02; F21V 17/06; F21V 21/06; F21V 23/02; F21V 23/04; F21W 131/10; F21Y 115/10

(52) U.S. Cl. CPC F21L 4/08; F21V 3/02; F21V 17/06; F21V 21/06; F21V 23/023; F21V 23/0464; F21W 2131/10; F21Y 2115/10

(57) ABSTRACT

Disclosed herein is a self-contained, solar-powered illuminated display orb comprising a clear body, an internal artwork element, and an integrated lighting assembly. A solar panel mounted on or adjacent to the orb collects solar energy during daylight hours and charges an internal power source. Upon detecting low ambient light conditions, a light-activated circuit powers one or more internal LEDs to illuminate the artwork from within the orb. The device may include a light diffuser through which the LEDs illuminate the artwork. The display orb may be supported on a base that may be at least partially reflective, to reflect ambient light onto the solar panel. The device operates automatically without external wiring and is designed for both indoor and outdoor decorative use.

### CROSS-REFERENCE TO RELATED APPLICATIONS

The entire contents of the following application are incorporated by reference herein: U.S. Provisional Patent Application No. 63/808,483; filed May 19, 2025; and entitled SOLAR-POWERED ILLUMINATED ART ORB.

### TECHNICAL FIELD

The present disclosure relates to art orbs, specifically art orbs that can be illuminated via solar power.

### BACKGROUND

Decorative glass orbs and similar display pieces are popular for ambient lighting and aesthetic appeal. However, most existing illuminated displays require external power or batteries, or they do not effectively showcase artwork inside the display. For example, a common “gazing ball” may glow at night but often lacks a way to highlight a specific art piece within it. There is a need for a self-contained, solar-powered device that can both collect energy and illuminate an internal piece of art, thereby providing an attractive display without external wiring.

### SUMMARY OF THE INVENTION

The foregoing, and other features and advantages of the invention, will be apparent from the following, more particular description of the preferred embodiments of the invention, the accompanying drawings, and the claims.

Disclosed herein, in some aspects, is an illuminated display device comprising: an at least partially transparent enclosure; an artwork element positioned within the enclosure; a solar panel configured to receive ambient light and generate electrical energy; a rechargeable power source coupled to the solar panel; and a light source positioned to illuminate the artwork element, wherein the light source is powered by the power source.

In some embodiments, the light source automatically activates in response to a reduction in ambient light. In some embodiments, the reduction in ambient light is detected via the solar panel. In some embodiments, the enclosure is spherical.

In some embodiments, the display device comprises i) an orb comprising the enclosure, and ii) a base configured to removably couple with the base, the base acting as a stand to support the orb. In some embodiments, the artwork element is a three-dimensional figurine.

In some embodiments, the display device comprises a lighting assembly comprising the solar panel, the power source, and the light source. In some embodiments, the lighting assembly further comprises a housing configured to house at least one of the solar panel, the power source, and the light source. In some embodiments, the lighting assembly further comprises a light diffuser, such that the light source is configured to illuminate the artwork element via the light diffuser. In some embodiments, the light source is mounted within a housing of the lighting assembly, within a perimeter of the light diffuser, or both, and wherein the light source is directed upward toward the artwork element. In some embodiments, the light diffuser comprises a platform about which the artwork element is configured to rest upon. In some embodiments, the solar panel is mounted about a bottom portion of the lighting assembly.

In some embodiments, the device further comprises a reflective base as a stand and also to reflect light onto the solar panel. In some embodiments, the light source comprises at least one light-emitting diode (LED). In some embodiments, the enclosure is sealed and weather-resistant for outdoor use. In some embodiments, the artwork element is suspended within the enclosure via a transparent support. In some embodiments, the enclosure comprises a frosted inner surface to diffuse the light from the light source.

In some embodiments, the solar panel, power source, and light source are housed within a removable base attached to the enclosure. In some embodiments, the solar panel is coupled to the enclosure via a flexible wire and mounted externally on a stake or surface.

In some embodiments, the enclosure comprises two separable hemispherical shells to allow replacement of the artwork element, replacement or repair of a lighting assembly, or both.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a front perspective view of an art orb, according to some embodiments.

FIG. 2 illustrates a back perspective view of the art orb of FIG. 1, according to some embodiments.

FIG. 3 illustrates a cross-sectional view of the art orb of FIG. 1, showing the internal components of the device, according to some embodiments.

FIG. 4 is an electronic schematic relating to the art orb of FIG. 1, according to some embodiments.

FIG. 5 illustrates a front perspective view of the art orb from FIG. 1 further comprising a transparent support, according to some embodiments.

### DETAILED DESCRIPTION OF THE INVENTION

Disclosed herein, in some aspects, is a display device that may use solar energy to illuminate (e.g., light up) an interior artwork. In some embodiments, the display device includes an at least partially transparent enclosure housing an artwork element (e.g., a figurine, sculpture, image, etc.) therewithin. The display device may include a light source configured to illuminate the artwork element. The light source may be configured to be powered by a solar-charged power source.

The light source may be configured to activate (e.g., illuminate) in response to a reduction in ambient light. For example, in the presence of daylight, the display device may include a solar capture mechanism (e.g., a solar panel) configured to capture sunlight so as to facilitate charging of a rechargeable battery. At night or in low light, the stored energy (of the rechargeable battery) may be configured to power the light source. In some cases, the solar panel is configured to and/or enables the display device to detect said low light or darkness, which may enable the light source to automatically illuminate. The light source may be positioned within the enclosure to illuminate the artwork element (e.g., shine light upon the artwork element), thereby causing the artwork element to be visible and highlighted.

As used herein, the display device may be of any shape and/or form factor. In some cases, the display device may include an orb (e.g., an art orb, a display orb, etc.). The orb may include the enclosure described herein. The orb may have a spherical, or substantially spherical shape. In other implementations, the orb could take on different shapes-such as a cylindrical lantern or a polygonal (geodesic) sphere-while employing the same solar illumination concept. The term ‘orb’ as used herein can encompass any largely transparent enclosure for the art and lighting components.

The light source may be any type, which may include light emitting diode(s) (LED(s)), and/or other types of light bulbs.

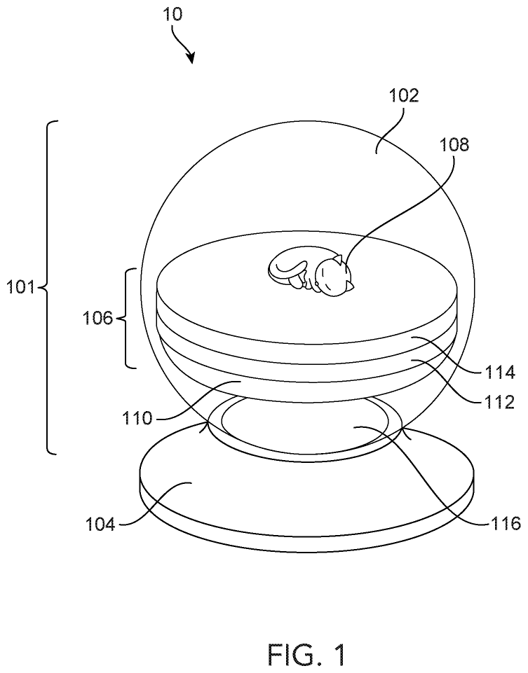

Referring to FIG. 1, an embodiment of the display device 10 is shown. The delivery device 10 may include an orb 101 and a base 104, wherein the orb 101 and the base 104 may be coupled together. The orb 101 may include an enclosure 102. The enclosure 102 may be at least partially transparent such that an internal of the enclosure may be at least partially visible externally. With respect to FIG. 1, the enclosure 102 is depicted as being transparent. The orb 101 and/or enclosure 102 may be any shape and/or form factor. FIG. 1 depicts the enclosure 102 as being spherical. The enclosure 102 may be made of a clear resin and/or similar material. In some embodiments, for any display device described herein, there is no enclosure, and thus the artwork element 108 is open and/or at least partially open to an external and/or ambient environment.

As depicted in FIG. 1, the orb 101 of the display device 10 includes a lighting assembly 106 disposed within the enclosure 102. Situated on top of the lighting assembly may be an artwork element. FIG. 1, for example, depicts artwork element 108, which appears as a cat figurine. Thus, both the lighting assembly 106 and artwork element 108 may be visible from outside the enclosure 102.

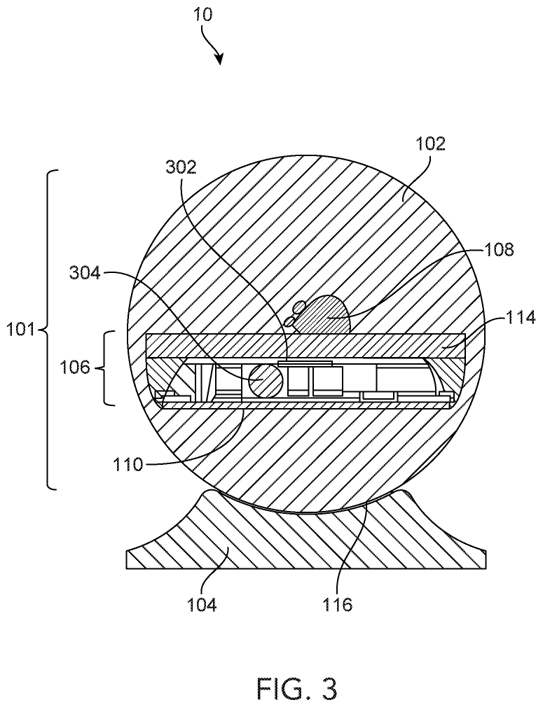

The lighting assembly 106 may include a battery (e.g., see battery 304 in FIG. 3), which may be rechargeable, a solar power capture device (e.g., solar panel 110), a light diffuser 114, and/or a light source (e.g., see light source 302 in FIG. 3). The light diffuser 114 may provide a platform so as to allow the artwork element 108 to rest and/or be restably coupled on top of the light diffuser 114. Accordingly, as depicted in FIG. 1, the artwork element 108 is centrally mounted within the orb 10, above the light diffuser 114, such that the lighting assembly 106 is able to illuminate the artwork element 108. The lighting assembly 106 may include a housing 112 to house at least partially one or more of the battery 304, solar panel 110, light diffuser 114, and light source 302. In some cases, the light diffuser 114 defines its own perimeter that is a separate component of housing 112.

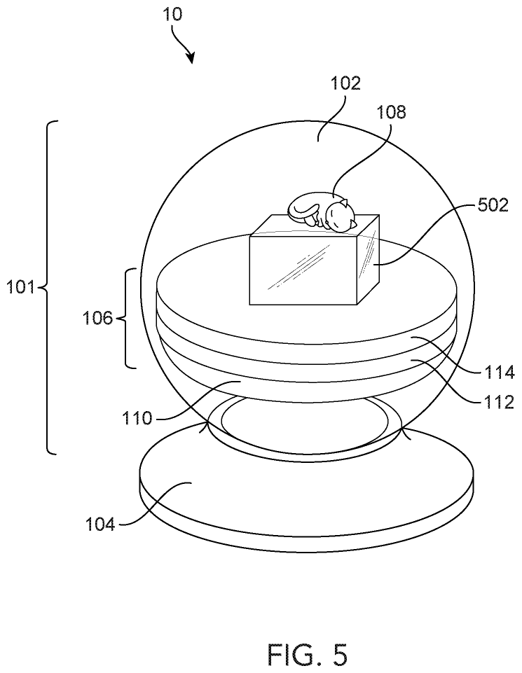

Alternatively or additionally, the artwork element 108 may be disposed about or on a transparent or at least partially transparent support, thereby providing the artwork element 108 with a suspended appearance. In some cases, the transparent support may be disposed on top of the light diffuser 114. See for example transparent support 502 in FIG. 5, where the artwork element 108 is disposed on said support 502. In some cases, the transparent support (e.g., 502 or a variation thereof) may be attached to an internal wall of the enclosure 102, and thereby suspended within the orb 101, which further provides the artwork element 108 with a suspended appearance. In such cases, the light and solar panel may be a part of the base (as described herein in another embodiment).

In use, the orb 101 may be placed in a location where the solar panel 110 can receive sunlight and/or other light. Thus, during the daytime (e.g., when the sun is out), the solar panel 110 may be configured to charge the battery 304. In some cases, when the ambient light falls below a threshold (such as at night), the light source (e.g., see light source 302 in FIG. 3) inside the lighting assembly 106 turns on, thereby casting light onto the artwork element 108, which in turn is visible through the transparent enclosure 102 of the orb 101. The solar panel 110 may be configured so as to detect when the ambient light falls below said threshold. For example, the solar panel may be configured to detect low light and/or darkness via an output voltage generated (i.e., generated when the light is received by the solar panel) by the received light, wherein lower voltage reflects dimmer light (as opposed to higher voltage that reflects more light). The light source may be automatically activated (i.e., turned on) via a controller (e.g., a microcontroller, as described herein) based on the detection of the ambient light falling below the threshold. Similarly, the detection of the ambient light level reaching and/or exceeding a threshold, such as based on an output voltage generated (by the received light) reaching and/or exceeding a threshold may enable the light source 302 to be turned off.

In some cases, a sensor may be situated about the lighting assembly 106 so as to detect the light becoming dimmer and/or a darkness based on a threshold, to automatically activate the light source 302.

In some embodiments, the artwork element 108 is a three-dimensional figurine made of translucent resin and/or silicone, which may allow light from the light source 302 to pass through the light diffuser 114 to create a glowing effect (on the artwork element 108). In some embodiments, the lighting assembly 106 does not have a light diffuser 114, and the light source 302 directly lights the artwork element 108. This may provide a more striking visual display in the dark.

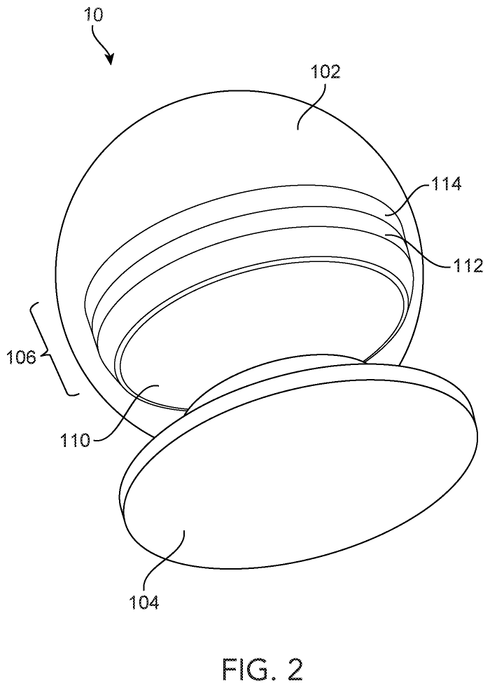

FIG. 2 depicts a back perspective view of the display device 10. As depicted, the enclosure 102 includes a solid sphere made of clear resin. In the depicted embodiment, the orb 101 and/or base 104 has an outer diameter of approximately 10 centimeters (cm). The orb 101 and/or base 104 can have an outer diameter ranging from about 5 cm to about 15 cm.

In some embodiments, the orb 101 (e.g., including the enclosure 102) may be made of glass and is a spherical shell rather than a solid body. The surface of the enclosure 102 might also be frosted or textured on the inside to diffuse the light from the light source 302 (e.g., LED), providing a gentle glow that illuminates the artwork element 108 uniformly.

FIG. 3 depicts a cross-sectional view of the display device 10, and thereby depicts a cross-sectional view of the orb 101 and of the lighting assembly 106. As depicted, the light source 302 may be disposed beneath the artwork element 108 and/or also beneath the light diffuser 114. As described herein, the light source 302 may include one or more LEDs. In some cases, the light source 302 is a ring of LEDs that encircles the base of the artwork element 108, where the LEDs may be oriented such that light is directed upward and outward toward the artwork element 108. The LEDs may be relatively small so as to position a number of LEDs about the lighting assembly 106 (e.g., beneath the artwork element 108 and/or light diffuser 114).

The light source 302 (e.g., LEDs) may be powered by a rechargeable battery 304 housed within a compartment (of the lighting assembly 106), such as near the bottom of the lighting assembly housing 112 and/or above the solar panel 110.

The solar panel 110 may be located about the bottom of the lighting assembly 106, and may be flush with a surface of the housing 112. In some cases the solar panel 110 includes a rectangular shape, a square shape, a circle, or any combination thereof, and is disposed about the lighting assembly 106. In some cases, the solar panel 110 includes a disc having a diameter. For example, the solar panel 110 may have a diameter ranging from about 4 cm to about 12 cm. The solar panel 110 may be configured to charge the battery 304 via a simple charging circuit.

In some cases, the solar panel 110 may be discreetly mounted, for example, on the orb's 10 top (e.g., enclosure 102) or base 104.

Alternatively or additionally, the artwork element 108 may be placed on a stand that reflects the sunlight coming from above onto the solar panel 110 below the art piece so the solar panel 110 does not have to be directly facing the sun to charge. For example, in some cases, there may be a mirror or other reflective material about the base 104 and/or the bottom of the orb 101 to facilitate reflection of light onto the solar panel 110. In a non-limiting example, a surface of concave portion 116 (as described herein, see FIG. 3), may include a reflective or at least partially reflective portion.

Alternatively or additionally, the solar collector (e.g., solar panel 110) is not on the orb itself but on a detachable base (e.g., 106) or stake. The orb (e.g., enclosure 102 or entire orb 101) may be designed to sit on a solar-powered base that contains the solar panel and battery, transmitting light into the orb via an LED at the base. This configuration might be useful for larger art orbs used as yard lights.

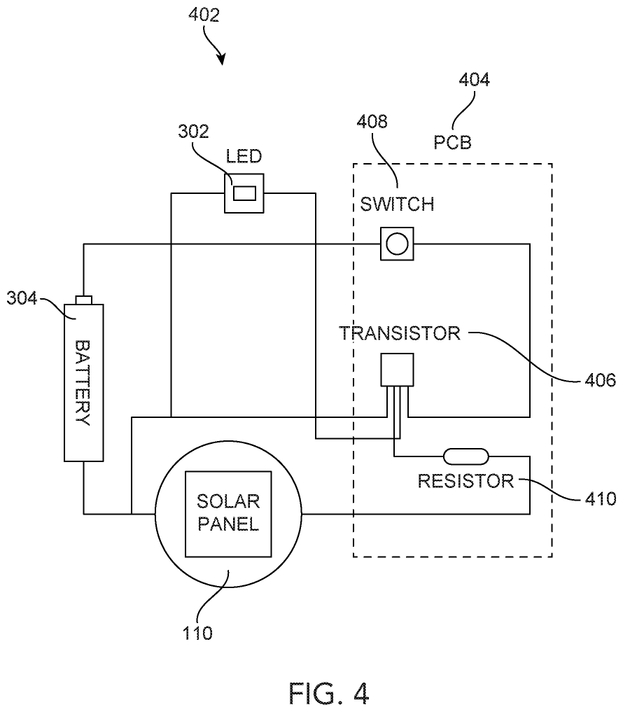

As described herein, in some cases, the display device 10 may further include a sensor configured to detect when an ambient light level is below a given threshold, thereby enabling the light source 302 to be automatically activated. The sensor may be disposed about the lighting assembly 106. For example, the sensor may be disposed about the lighting assembly housing, and/or about a portion of the solar panel 110. The sensor may be any type of sensor for detecting a low level of light. For example, the sensor may be a photocell/photoresistor, phototransistor and/or photodiodes, and/or photoelectric sensors. In some cases, as light decreases, a photoresistor's resistance increases, which may lower a voltage in a circuit, and thereby trigger a switch (e.g., see FIG. 4).

As depicted in FIGS. 1-3, the lighting assembly 106 may be disposed within the enclosure 102. The lighting assembly may be removably coupled with the enclosure 102. For example, the enclosure 102 may comprise two separable hemispherical shells to allow replacement of the artwork and/or replacement or repair of the lighting assembly 106. The lighting assembly 106 may include a housing (such as, for example, housing 112) to house the electronic components (light source 302, battery 304, an optional sensor, and/or associated wiring), which can be sealed into the enclosure 102 to form a watertight enclosure. This ensures the aesthetic of the orb is maintained while making it possible to access the electronics for repair or battery replacement if necessary. The materials used are generally weather-resistant, allowing the orb 10 to be used as an outdoor garden feature or an indoor decorative piece. The orb 10 may be a sealed unit, with the electronic components (solar cell, battery, LED, and any circuitry) incorporated in a way (e.g., with the lighting assembly 106) that does not detract from the orb's aesthetics. This invention thus elegantly combines solar lighting technology with artistic display, creating a decorative orb that automatically shines light on the artwork element it encases.

Moreover, the orb 101 may be removably coupled to the base 104. In some cases, the base 104 may include a concave portion 116 configured to receive the enclosure 102 of the orb, so as to allow the orb 101 to rest and be stable about the base 104. The concave portion 116 may include a profile that at least partially corresponds with the curvature of the enclosure 102. In some cases, the top and bottom of the enclosure 102 are mechanically attached with screws so that the internal battery (and/or other electronic components) can be replaced.

FIG. 4 depicts an example electronic flow diagram (e.g., circuit 402) for the display device 10. The solar panel 110, the battery 304, a transistor 406, the light source 302, a switch 408, and/or the resistor 410 may be electrically coupled with each other. The coupling may be electrical wiring. The transistor 406, the switch 408, and/or the resistor 410 may be disposed about and/or on a printed circuit board (PCB) 404. The PCB may include a microcontroller and/or a controller.

As described herein, the solar panel 110 may be configured to receive sunlight and convert it into energy for charging the battery 304. Accordingly, the battery 304 may be electrically coupled with the solar panel 110. The PCB may be configured to activate and/or deactivate the light source 302. For example, the amount of energy converted from the light received by the solar panel 110 may include voltage generated. In some cases, the switch 408 may be triggered based on a voltage in the circuit. For example, if the voltage decreases below a threshold, the switch 408 may be triggered to allow for light source 302 to be activated. The transistor 406 may enable the switching of current from the different components in the circuit 402.

Alternatively or additionally, the amount of voltage generated may be detected via a controller or microcontroller about the PCB 404, which may be configured to allow for the switch 408 to be triggered, to activate the light source 302.

In some cases, the solar panel 110 is configured to output from about 1 volt (V) to about 10 V based on received light. In some cases, the light source 302 includes LED as white 10 lumen LED. In some cases, the battery includes from about 0.5 V to about 10 V, such as a 1.5 V, 500 milliampere-hour (mAh) Nickel-Metal Hydride (Ni-MH) cell, which may provide from about 2 hours to about 16 hours of illumination on a full charge.

In some embodiments, the light source 302 may include multiple LEDs of different colors (for instance, red, green, and blue LEDs) to produce various lighting effects. A controller (e.g., as described herein) could be added to cycle through colors or create patterns of illumination on the artwork.

In some additional or alternate embodiments, the light source 302 includes a liquid crystal display (LCD) or an organic LED (OLED) panel to create video visual light effects.

In some cases, multiple orbs 101 may be linked together through wireless data transmission (for example, via each respective PCB 404 of a given orb 101) to create complex and/or coordinated lighting effects. In some cases, the orb 101 includes radio frequency identification (RFID) chip(s) embedded (e.g., about the orb 101, base 104, and/or PCB 404) for tracking purposes.

In some embodiments, the orb 101 and/or enclosure 102 can be mounted onto a pole for use as signage, such as a street number for a home or for the name of a business. In some embodiments, a ring is attached to the orb 101 for hanging as an accessory or ornament.

In some embodiments, the orb 101 can be used for specific game types, such as billiards or bowling. In some embodiments, the orb 101 includes an integrated timer for use in a game activity.

In some embodiments, the artwork element 108 may include a 3D representation of a person's face, which can serve as a memory of a loved one or a deceased person. A version with a pet may also be depicted. Additionally or alternatively, the artwork element 108 may be a flat image or patterned film applied to the interior of the orb 101, rather than a 3D object. For example, the orb 101 could contain a transparent sleeve that holds interchangeable printed artwork, allowing the design to be changed.

In some embodiments, the artwork element 108 is configured to be floating in the center of the orb 101. In some embodiments, the artwork element 108 is a video display. The orb 101 may be configured to create a multimedia show.

In contrast to known decorative orbs and solar garden lights, which either lack internal artwork or rely on external power, the present invention uniquely integrates a self-contained solar power system with an interior art display. This combination of a sealed transparent orb, an internal art piece, and an automatic solar-powered illumination mechanism has not been previously realized in the prior art. By leveraging solar technology, the invention solves the problem of illuminating artwork without external wiring or batteries, a solution which was not obvious to practitioners in the field.

### Numbered Embodiments

Embodiment 1: A self-contained illuminated display device comprising: a transparent enclosure; an artwork element positioned within the orb; a solar panel configured to collect ambient light and generate electrical energy; a rechargeable power source coupled to the solar panel; and at least one light-emitting diode (LED) positioned to illuminate the artwork element, wherein the LED is powered by the power source and automatically activates in response to a reduction in ambient light.
Embodiment 2: The device of Embodiment 1, wherein the transparent enclosure is spherical.
Embodiment 3: The device of Embodiment 1, wherein the artwork element is a three-dimensional figurine.
Embodiment 4: The device of Embodiment 1, wherein the solar panel is mounted on a bottom portion of the enclosure.
Embodiment 5: The device of Embodiment 1, wherein the rechargeable power source is a lithium-ion battery.
Embodiment 6: The device of Embodiment 1, wherein the LED is mounted within a base portion of the enclosure and directed upward toward the artwork element.
Embodiment 7: The device of Embodiment 1, further comprising a reflective base as a stand and also to reflect light onto the solar panel.
Embodiment 8: The device of Embodiment 1, wherein the LED produces a color-changing illumination effect.

Embodiment 9: The device of Embodiment 1, wherein the enclosure is sealed and weather-resistant for outdoor use.

Embodiment 10: The device of Embodiment 1, wherein the artwork element is suspended within the enclosure via a transparent support.

Embodiment 11: The device of Embodiment 1, wherein the enclosure comprises a frosted inner surface to diffuse the light from the LED.

Embodiment 12: The device of Embodiment 1, wherein the artwork element is interchangeable.

Embodiment 13: The device of Embodiment 1, wherein the solar panel, battery, and LED are housed within a removable base attached to the enclosure.

Embodiment 14: The device of Embodiment 1, wherein the transparent enclosure is made of clear resin.

Embodiment 15: The device of Embodiment 1, wherein the artwork element comprises a translucent material that transmits light.

Embodiment 16: The device of Embodiment 1, wherein the LED is one of a plurality of LEDs arranged around the artwork element.

Embodiment 17: The device of Embodiment 1, wherein the enclosure is not spherical but cylindrical or polygonal in shape.

Embodiment 18: The device of Embodiment 1, wherein the solar panel is coupled to the enclosure via a flexible wire and mounted externally on a stake or surface.

Embodiment 19: The device of Embodiment 1, wherein the enclosure comprises two separable hemispherical shells to allow replacement of the artwork and replacement or repair of the lighting assembly.

Embodiment 20: The device of Embodiment 1, wherein the device has a microprocessor included in the assembly to provide complex lighting displays.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” refers to less than or equal to +/−1%, +/−2%, +/−3%, +/−4%, +/−5%, +/−6%, +/−7%, +/−8%, +/−9%, +/−10%, +/−11%, +/−12%, +/−14%, or +/−15% variation. As a non-limiting example, substantially parallel represents a range of −1 to 1 degree difference, −5 to 5 degree difference, or −15 degrees to 15 degrees of difference from being parallel, depending on the embodiments.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

I claim:

1. An illuminated display device comprising:
an at least partially transparent enclosure;
an artwork element positioned within the enclosure;
a solar panel configured to receive ambient light and generate electrical energy;
a rechargeable power source coupled to the solar panel; and
a light source positioned to illuminate the artwork element, wherein the light source is powered by the power source.

2. The device of claim 1, wherein the light source automatically activates in response to a reduction in ambient light.

3. The device of claim 2, wherein the reduction in ambient light is detected via the solar panel.

4. The device of claim 1, wherein the enclosure is spherical.

5. The device of claim 1, wherein the display device comprises i) an orb comprising the enclosure, and ii) a base configured to removably couple with the base, the base acting as a stand to support the orb.

6. The device of claim 1, wherein the artwork element is a three-dimensional figurine.

7. The device of claim 1, where the display device comprises a lighting assembly comprising the solar panel, the power source, and the light source.

8. The device of claim 7, wherein the lighting assembly further comprises a housing configured to house at least one of the solar panel, the power source, and the light source.

9. The device of claim 7, wherein the lighting assembly further comprises a light diffuser, such that the light source is configured to illuminate the artwork element via the light diffuser.

10. The device of claim 9, wherein the light source is mounted within a housing of the lighting assembly, within a perimeter of the light diffuser, or both, and wherein the light source is directed upward toward the artwork element.

11. The device of claim 9, wherein the light diffuser comprises a platform about which the artwork element is configured to rest upon.

12. The device of claim 7, wherein the solar panel is mounted about a bottom portion of the lighting assembly.

13. The device of claim 1, further comprising a reflective base as a stand and also to reflect light onto the solar panel.

14. The device of claim 1, wherein the light source comprises at least one light-emitting diode (LED).

15. The device of claim 1, wherein the enclosure is sealed and weather-resistant for outdoor use.

16. The device of claim 1, wherein the artwork element is suspended within the enclosure via a transparent support.

17. The device of claim 1, wherein the enclosure comprises a frosted inner surface to diffuse the light from the light source.

18. The device of claim 1, wherein the solar panel, power source, and light source are housed within a removable base attached to the enclosure.

19. The device of claim 1, wherein the solar panel is coupled to the enclosure via a flexible wire and mounted externally on a stake or surface.

20. The device of claim 1, wherein the enclosure comprises two separable hemispherical shells to allow replacement of the artwork element, replacement or repair of a lighting assembly, or both.
